(19) United States
(12) Patent Application Publication
(10) Pub. No.: US 2016/0260172 A1
(43) Pub. Date: Sep. 8, 2016

(54) COMPUTERIZED ORDER MATCHING WITH FEES SELECTABLE BY PARTICIPANTS

(71) Applicant: TSX INC., Toronto (CA)

(72) Inventors: Deana DJURDJEVIC, Toronto (CA); Kevin SAMPSON, Toronto (CA)

(21) Appl. No.: 15/033,300

(22) PCT Filed: Jun. 3, 2014
(86) PCT No.: PCT/CA2014/000477

§ 371 Date: Apr. 29, 2016

Related U.S. Application Data
(60) Provisional application No. 61/907,637, filed on Nov. 22, 2013.

(51) Int. Cl. G06Q 40/04

(52) U.S. Cl. CPC G06Q 40/04

(57) ABSTRACT

Passive or rested orders can be priority ranked in an order book database based on price and further based on fee indications for the rested orders. Fee indications may include rebate give-ups that are given to the entities making active orders. Newly incoming or active orders are matched to rested orders according to the ranking. Entities trading passively may thus be able to prioritize rested orders by way of selectable rebate give-up, and further may peg rebate give-up at or above the market. Entities trading actively may specify a minimum rebate give-up required from the book to effect a trade.

### CROSS-REFERENCE TO RELATED APPLICATIONS

This application claims priority to U.S. 61/907,637, filed Nov. 22, 2013, the entirety of which is incorporated herein by reference.

### FIELD

This present invention relates to computers and, more specifically, to computerized trading.

### BACKGROUND

Computerized exchanges typically offer to execute trades for a fixed fee, which may be broadly applicable to all financial securities (e.g., stocks) regardless of market conditions. In one scenario, active orders are charged fees and passive orders rested in an order book are given rebates by the exchange facilitating the trade. The exchange may charge a fee that is higher than the rebate given, so as to cover costs and earn profit. In an inverted scenario, active orders are given rebates and passive orders are charged fees, with a similar fee-rebate differential taken by the exchange. Regardless of the direction of the fee and rebate, past approaches are one-size-fits-all and hence do not allow for market input.

### SUMMARY

Passive or rested orders can be priority ranked in an order book database based on price and further based on fee indications for the rested orders. Fee indications may include rebate give-ups that are given to the entities making active orders. Newly incoming or active orders are matched to rested orders according to the ranking. Entities trading passively may thus be able to prioritize rested orders by way of selectable rebate give-up, and further may peg rebate give-up at, above or below the market. Entities trading actively may specify a minimum rebate give-up required from the book to effect a trade.

### BRIEF DESCRIPTION OF THE DRAWINGS

The drawings illustrate, by way of example only, embodiments of the present invention.

FIG. 1 is a block diagram of a computer system.

FIG. 2 is a block diagram of a trading server.

FIG. 3 is a schematic diagram of an order book database and processing of new orders.

FIG. 4 is a flowchart of a method of trading with selectable rebate give-ups.

FIG. 5 is a diagram of an example order book showing rebate give-ups.

FIG. 6 is a table of fields or tags for specifying rebate give-ups.

### DETAILED DESCRIPTION

Fees and rebates can be provided by an exchange to incentivize market takers and makers. The techniques discussed herein allow participants in computerized trading systems to dynamically determine the fees/rebates for specific financial securities, thereby allowing fees/rebates to be steered by prevailing market conditions. This may allow for improved matching of orders and increased competition in an order book.

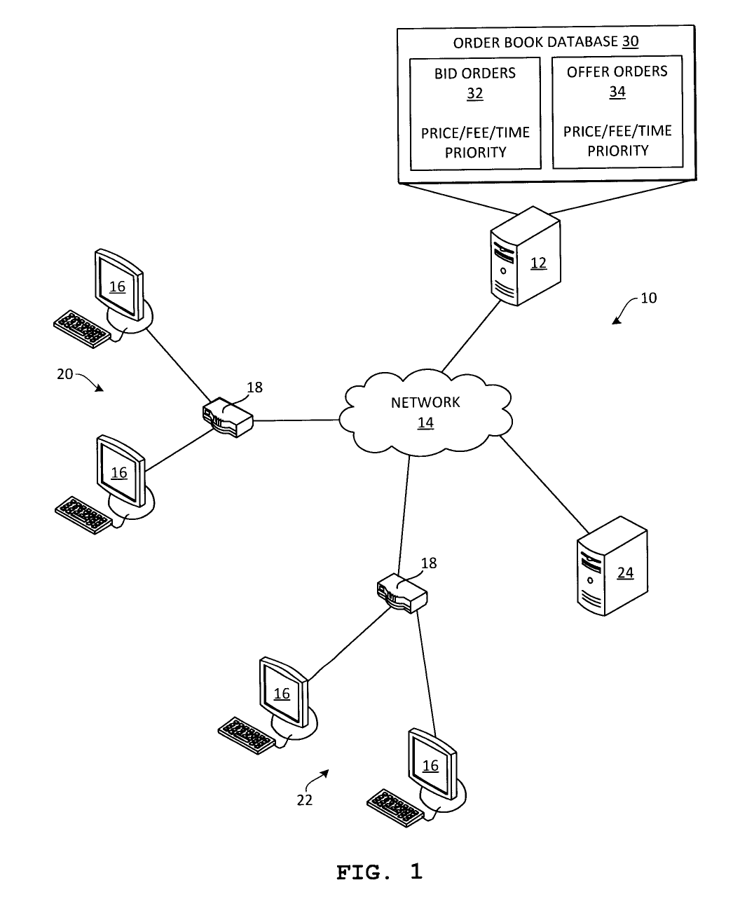

FIG. 1 shows a computer system 10 configured to allow trading of financial securities, such as equity securities and the like. Stocks will be used as an illustrative example. However, this is not limiting and the techniques discussed herein can be applied to exchange-traded funds (ETFs) and similar or other financial products, financial instruments, or securities.

The system 10 includes at least one trading server 12 connected to one or more computer networks 14. The trading server 12 is in the domain of a computerized exchange and is accordingly controlled by an exchange corporation or entity.

The system 10 further includes trading computers 16 connected to the network 14 via network devices 18, such as access points, routers, servers, and similar. The trading computers 16 belong to various domains 20, 22 controlled by different trading entities, such as brokers and the like. The trading computers 16 execute trading client programs that allow input of orders, transmission of orders to the trading server 12, and reception and output of results of such orders.

The system 10 may further include other servers 24 connected to the network 14. The other servers 24 may provide various other functions, such as publishing price/fee data received from the trading server 12, aggregating price/fee data, and similar. The other servers 24 may operate in various domains.

The network 14 can include any number and type of computer networks, such as a local area network (LAN), wide-area network (WAN), virtual private network (VPN), intranet, and the Internet. The network 14 operates to communicatively couple the trading server 12, the various trading computers 16, and the other servers 24, while isolating domains from one another and restricting communications between domains.

The trading server 12 includes an order book database 30. The order book database 30 may be referred to as a central limit order book (CLOB). The trading server 12 is configured to process orders that contain fee indications and to rest orders at the order book database 30 according to price-fee-time priority. The fee component of price-fee-time priority can be realized in a variety of ways. In the present examples, the fee component includes a rebate differential (give-up) indicative of an amount of rebate that the market maker is willing to give up to the taker. Price-rebate give-up-time priority means that rested orders are first ranked based on price, then ranked based on rebate give-up where price is the same, and finally ranked based on time where rebate give-up is the same. Hence, orders at the same price level are ranked on rebate give-up, and orders with the same fee are ranked based on age, with older orders being processed ahead of newer orders. It is contemplated that the order book database 30 is configured as a table of bid orders 32 and a table of offer orders 34, each ranked in price-rebate give-up-time priority. It is also contemplated that ranking based on rebate give-up is from highest-to-lowest rebate give-up provided to the taker, i.e., the trading entity behind an incoming (active) order that lifts a rested (passive) order from the book. Thus, orders are ranked in a manner that benefits the taker. It is worth noting that this rebate give-up may be negative, in that the maker may be given an increased rebate for providing liquidity in the order book. As will be discussed further below, fees can be negotiated by makers and takers by way of providing fee indications with orders.

Trading computers 16 are configured by a client program to allow input of fee indications. The trading server 12 is configured to match an incoming order to one or more complementary orders, if present in the order book database 30, and to rest the incoming order, or unmatched part thereof, in the order book database 30. Trading entities in control of the trading computers 16 can advantageously specify fee indications for active orders to lift orders with matching fee indications from the book. Further, resting fee indications can be specified with incoming orders, so as to increase or decrease the order's priority if it, or a portion of it, hits the book. An order that is required to be matched quickly can be specified to have a fee indication that offers increased consideration to the entity providing the matching order. Conversely, orders can be selected to have fulfillment delayed by specifying fee indications that offer less consideration.

Fee indications can take various forms, and no form should be taken as limiting. Fees may be expressed in mils, where one mil (or mill) is one thousandth of a unit of currency (e.g., 1/1000 dollar) per share traded. For example, if 1000 shares are traded, a 35 mil fee amount would be $3.50 and a 31 mil rebate amount would be $3.10.

In various examples, a rested order may indicate the maximum rebate that a trading entity is willing to give up to have the rested order prioritized, and a new incoming order may indicate the maximum fee that a trading entity is willing to pay.

In the examples used in this disclosure, orders specify the fee indication as a rebate differential from a base rebate. That is, if an exchange has a base rebate of 31 mils, then the fee indication can be expressed as a rebate differential (or give-up), such as 5 mils, 10 mils, 15 mils, etc., which expresses how much of the rebate that the passive trading entity is willing to give up to the active trading entity. Thus, in the example of a 5 mil rebate differential, the passive trading entity would receive a 26 mil rebate (i.e., 5 mils less than the base rebate of 31 mils) and the active trading entity would pay a fee of 30 mils (i.e., 5 mils less than the base fee of, for example, 35 mils). The exchange still earns the fee-rebate spread (i.e., 4 mils), but the passive entity (maker) has agreed to give up some of their rebate as consideration to the active entity (taker) in order to gain priority for their passive order in the order book database 30. Further, rebate give-ups may be specified to exceed the base rebate, such that the maker who books a passive order pays a fee (i.e., a negative rebate), which may result in the taker earning a rebate (i.e., a negative fee). For example, a rested order may specify a 40 mil rebate give-up, which is greater than the example base rebate of 31 mils, resulting in the maker paying a fee of 9 mils (i.e., 31−40=−9 mil rebate=+9 mil fee) and the taker earning a rebate of 5 mils over the example base fee of 35 mils (i.e., 35−40=−5 mil fee=+5 mil rebate).

In addition, a passive entity can specify a rebate give-up that ends up being greater than what the market requires to match the entire order. Similarly, an active entity can specify a minimum rebate give-up that ends up being smaller than what the market is offering. Accordingly, rebate give-ups for passive orders may be considered by the exchange to be maximum rebate give-ups, and minimum rebate give-ups accompanying active orders may be considered by the exchange to be minimum rebate required. The actual rebate give-up used in fee and rebate amount calculations is that of the passive order.

The fee indication can be stored and transmitted in various different ways. In one example, the fee indication is provided in a designated field or tag of an order, which can conform to one or more various electronic trading protocols such as the Financial Information eXchange (FIX) protocol maintained by FIX Protocol, Ltd. as well as proprietary exchange protocols such as STAMP and the like. In another example, the fee indication is provided by way of a specific type of order (e.g., a “fee rebate” order type) with its own set of fields and tags including a field or tag specifying the value of the fee indication. In yet another example, a different specific type of order is provided for each different permitted fee indication (e.g., “5 mil rebate delta” order type, “10 mil rebate delta” order type, etc.).

In addition, an order can have its rebate give-up pegged at, above or below the highest rebate give-up of orders at the same price level in the order book database 30. Orders are configured to specify an optional rebate peg offset that triggers the order adopt a rebate give-up that is above the highest rebate give-up by the rebate peg offset. Further, to guard against undesirably high rebate give-ups, orders can be configured to specify a rebate peg limit that a pegged rebate give-up cannot exceed. For example, if the highest booked rebate give-up is 15 mils, then a new order may specify a rebate peg offset of 5 mils and a rebate peg limit of 30 mils. The new order would then adopt a rebate give-up of 20 mils (i.e., 15+5) which would float as the highest booked rebate changed. However, the rebate give-up would not float to exceed 30 mils, and instead would remain at 30 mils if the highest booked rebate exceeded 25 mils.

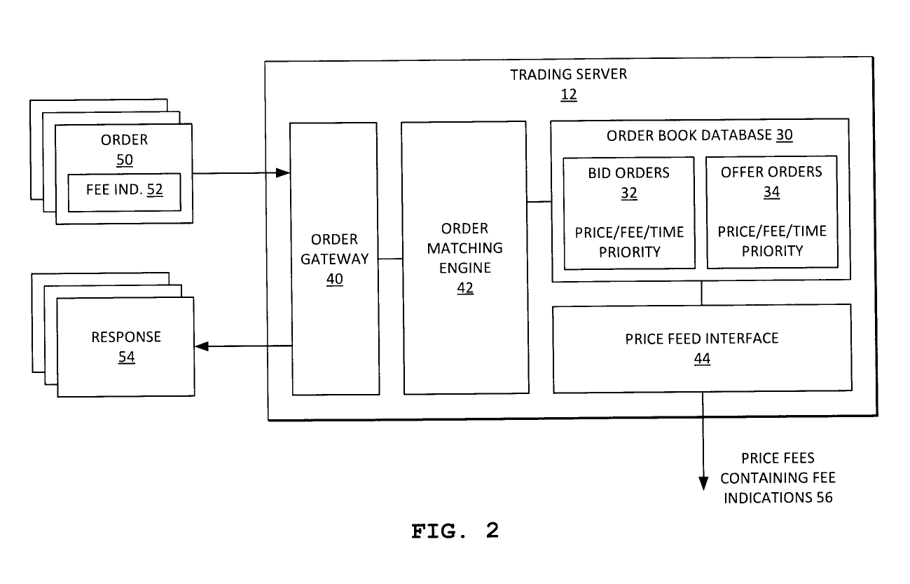

FIG. 2 shows details of the trading server 12. The trading server 12 can include any suitable computer, which can include one or more processors, one or more field-programmable gate arrays (FPGAs), memory (e.g., RAM, cache, etc.), mass storage devices, network adaptors, and user interface devices. These components are omitted from the figure for clarity. The components illustrated and discussed below may be implemented by programs stored in memory and executable by a processor or stored and executed by an FPGA.

The trading server 12 includes an order gateway 40, an order matching engine 42, the order book database 30, and a price feed interface 44. The components 40, 42, 30, 44 are illustrative and the distinct functionalities thereof may be combined into larger components or separated into smaller components based on specific implementation requirements. When more than one trading server 12 is used, the components 40, 42, 30, 44 may be distributed among the servers 12 in various ways.

The order gateway 40 is configured to receive orders 50, which may contain fee indications 52, from various trading computers 16 (FIG. 1) and to validate such orders 50. Because the orders 50 may be expressed in a protocol not used internally to the server 12, the order gateway 40 can also be configured to translate orders 50 from their protocols into a schema used within the trading server 12. An example of a suitable schema is a class that has properties, where one of such properties is configured to store a value of a fee indication. The order gateway 40 can be configured to map the fee indication specified by a specific order 50 to the respective property of a specific instance of the class. Such a class may be used to instantiate database objects compatible with the order book database 30.

The order gateway 40 can also be configured to timestamp orders 50 upon receipt by, for instance, reading a hardware clock of the server 12 and writing a timestamp to a property of the order class instance.

The order gateway 40 can further be configured to send responses 54 to the various trading computers 16, where the responses are configured to indicate whether and how orders 50 have been received and processed.

The order matching engine 42 is configured to process orders 50 by matching incoming orders 50 with orders present in the order book database 30. The order matching engine 42 is configured to rest an order 50 or a portion of an order 50 in the order book database 30, when the order or portion thereof is not able to match or if specified by the order 50. The order matching engine 42 is specifically configured to match orders 50 with reference to fee indications 52, as will be discussed in further detail below.

The price feed interface 44 is configured to obtain data from the order book database 30 and construct data feeds 56 from such data. Feeds 56 can contain price and volume information for various markets (e.g., stock symbols), and can further include fee indications. For example, a feed 56 may directly reflect the order book database 30 by indicating a bid order of 5,000 shares of a stock at $10 with a rebate give-up of 10 mils. Feeds 56 can be configured to aggregate or average information concerning fee indications. For example, a feed 56 may indicate that 22,000 shares of a stock are subject to offer orders at $10 with an average rebate give-up of 7.2 mils. In such example, the rebate indication may be indicated as a lowest rebate give-up for a block of shares, a highest rebate give-up for a block of shares, or simply an indication that a rebate give-up exists for a block of shares. Feeds may be provided to servers 24 (FIG. 1) and available to trading computers 16 as well as the general public.

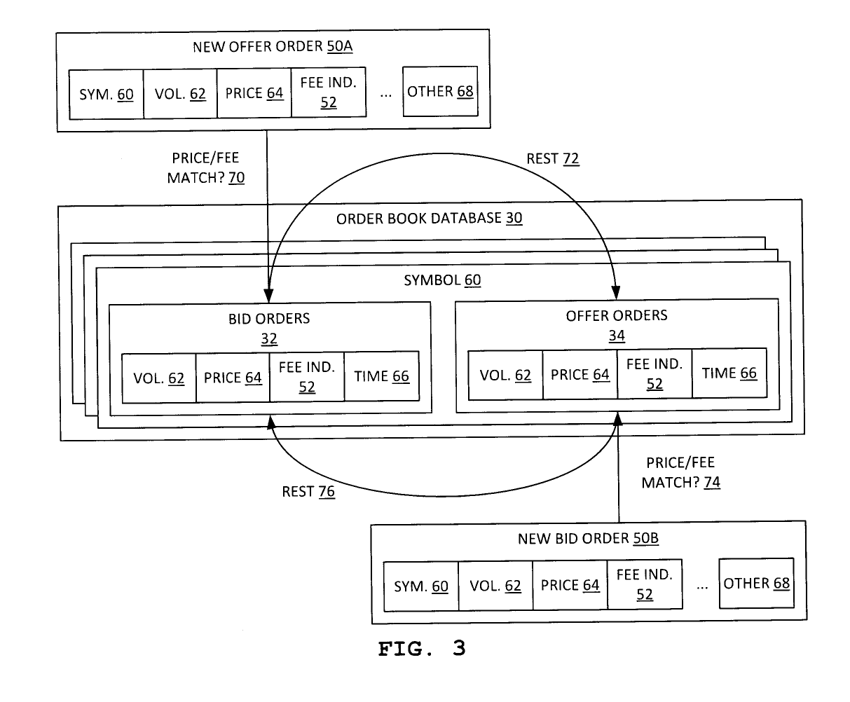

FIG. 3 shows the order book database 30. The order book database 30 can be indexed by market (e.g., stock symbol) 60. For each symbol 60, the order book database 30 can include one or more tables of bid orders 32 and offer orders 34, which include data fields for volume 62, price 64, time 66, and fee indication 52. Other data fields 68 can also be provided.

The volume and price fields 62, 64 represent an amount of shares to trade at the specified price. The time field 66 indicates the time that an order was received, provided for by the timestamp issued by the order gateway 40. Further, the order gateway 40 can be configured to issue a new timestamp to an order that is amended to add, remove, or change a rebate give-up, thereby altering the time component of the price-rebate give-up-time priority of the order in the order book database 30. Various combinations of adding, removing, and changing a rebate give-up to trigger a new timestamp are contemplated. A new timestamp based on an added, removed, or changed rebate give-up can be issued independently to any other amendments to the order that may not require a new timestamp. For example, when an order is amended to increase the rebate give-up, a new timestamp can be provided to the order, and it may be beneficial to refrain from issuing a new timestamp to an amended order if the rebate give-up is decreased. In another example, a new timestamp is issued any time an order is amended to add, remove, increase, or decrease a rebate give-up. Other examples are also contemplated.

New orders 50A, 50B are also shown in FIG. 3 and the above description concerning orders 50 can be referenced for further detail. New orders 50A, 50B may specify a minimum rebate give-up as the fee indication 52. New orders 50A, 50B are considered active orders and are thus capable of demanding a rebate give-up from the order book database 30. Conversely, orders 32, 34 rested in the order book database 30 are considered passive orders and are thus contemplated to provide a rebate give-up so as to gain priority in the book so as to ultimately be matched and executed. Accordingly, new orders 50A, 50B may also specify a resting rebate give-up that takes effect if the new order 50A, 50B, or a remainder thereof, is rested in the order book database 30.

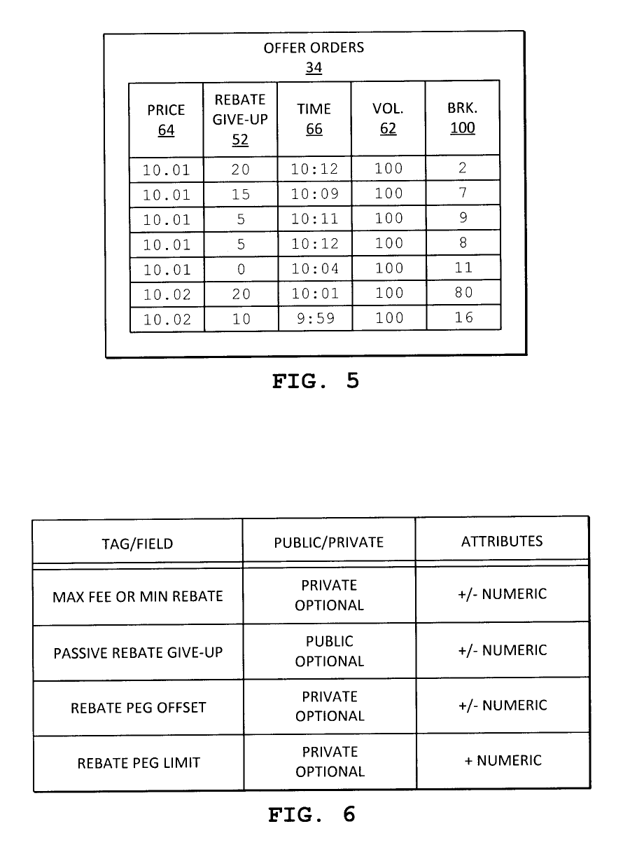

By way of example, the order matching engine 42 is configured to process a new offer order 50A by first determining, at 70, if the new offer order 50A matches one or more of the highest priority rested bid orders 32. To make this determination, the bid orders 32 can be priority ranked: first by descending price, then by descending rebate give-up, and finally by timestamp (oldest to newest). See FIG. 5 for an example. One or more bid orders 32 having a total volume 62 that matches the volume 62 of the new offer order 50A are then evaluated as a subset of bid orders 32. If the new offer order 50A is specified to be a market order, then the subset of bid orders 32 are considered to match the new offer order 50A and the fees and rebates are calculated based on the fee indications 52 (i.e., rebate give-ups) of the subset of bid orders 32. If the new offer order 50A is not a market order, then each bid order 32 of the subset is considered, starting with the bid order 32 of highest priority, then moving to the next highest priority, and so on. The new offer order 50A is considered a match a given bid order 32 when the price matches and the bid order's resting rebate give-up is greater than or equal to a minimum rebate give-up, if specified in the new offer order 50A. For example, if the price specified in the new offer order 50A is $10 and the minimum rebate give-up is 5 mils, then the new offer order 50A will match bid orders 32 that have a price of $10 (or greater) and a resting rebate give-up of 5 mils or greater. After the new offer order 50A has been compared to the subset of bid orders 32 and filled, then the order matching engine 42 reports to the order gateway 40 that the new offer order 50A has been filled at what price(s) and rebate give-up(s), so that the order gateway 40 can issue responses 54 to the trading computers 16 concerned. The order matching engine 42 executes partially filled orders similarly, if the new offer order 50A allows (e.g., not fill-or-kill). If the new offer order 50A cannot be matched with the subset of bid orders 32, or if there is a remainder of a partially filled new offer order 50A that will not lock the market, then the order matching engine 42 rests, at 72, the new offer order 50A (or remainder thereof) in the order book database 30 at a priority determined by any resting rebate give-up specified in the fee indication 52 of the offer order 50A.

Similarly, the order matching engine 42 is configured to process a new bid order 50B in the same manner by comparing, at 74, the new bid order 50B with the price-fee-time ranked offer orders 34, and resting, at 76, the new bid order 50B or remainder thereof, if not matched. The new bid order 50B or remainder thereof is rested with a specified resting rebate give-up, if any, contained in the fee indication 52 of the bid order 50B, so that the rested order's priority can be established when a subsequent new offer order 50A arrives.

Thus, it should be apparent from the above that entities trading actively can select minimum rebate give-ups for new orders 50A, 50B, so as to quickly lift the high priority passive orders from the order book database 30. Further, entities trading passively, can select resting rebate give-ups for new orders 50A, 50B that are expected to be rested (or as a contingency against being rested), so as to have some input as to how and at what cost the order can be lifted from the book.

The above examples are merely illustrative. It is contemplated that rebate give-ups can be negative, such that incoming active orders incur a greater fee and booked passive orders receive a greater rebate. Further, it is mentioned again that the techniques described herein can be applied to financial instruments other than stocks.

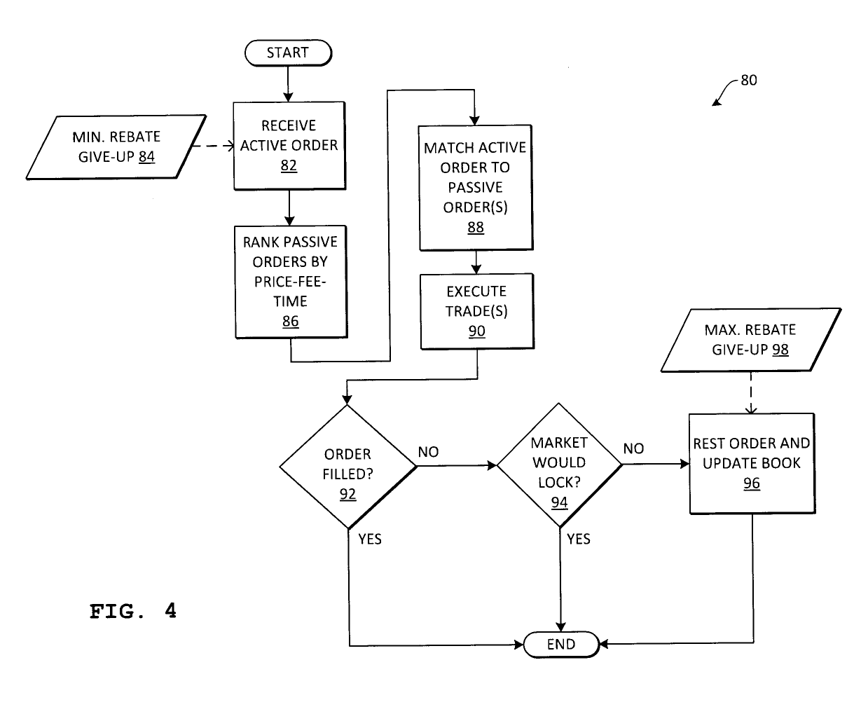

With reference to FIG. 4, the order matching engine 42 can be configured to process active orders against a book of passive orders according to a method 80. The method 80 is described as having discrete steps or blocks, however, this should not be taken as limiting. Various steps or blocks of the method 80 can be combined or further separated. Moreover, it is contemplated that the order in which steps or blocks are performed can be modified.

At 82, the order matching engine 42 receives a new active order via the order gateway 40. The new order may specify a fee indication, such as a minimum rebate differential (give-up) 84 required to have the order matched. That is, rested orders at the same price level that do not meet at least the minimum rebate give-up 84 will not be matched to the new order. The new order may also specify a resting rebate give-up in the event that the new order, or a portion thereof, is rested in the order book database 30 and becomes passive.

Next, at 86, the order matching engine 42 ranks rested orders in the order book database 30 by priority based on price, then rebate differential (give-up) for the same price, and then timestamp (oldest before newest) for the same rebate give-up. Hence, trading entities willing to give up larger portions of their rebates will have their passive orders ranked higher than those not willing to give up as much rebate.

At 88, the new order is matched to as many of the rested orders as necessary and as possible to meet the volume specified in the new order. Matching is performed according to the rested order ranking determined at 86, so that rested orders at the same price as the new order are matched based on priority of rebate give-up, with higher rebate give-ups being matched before lower rebate give-ups. Further, any minimum rebate give-up specified for the new order is considered in the matching process, such that rested orders at the same price but with rebate give-ups less than the minimum specified by the new order are not matched to the new order. It should be noted that the same price includes prices that are not exactly identical but that meet the requirements of both the entity behind the new order and the entity behind the rested orders. That is, a new bid order that exceeds the market offer price is considered to be the “same” price as the market offer price for purposes of matching. Likewise, a new offer order that is priced below the market bid price is considered to be the “same” price as the market bid price.

In addition, when a next-in-line booked order does not meet a minimum rebate give-up specified in the new order, the next-in-line booked order can be considered a bypassed order. The new order can be prevented from trading through bypassed orders, booking at a bypassed order's price, and trading through better away market orders (i.e., orders booked on exchanges different from the exchange operating the server 12) unless specified to be a directed action order (DAO). An example DAO is an order that contains an instruction for the server 12 to not check for better-priced orders on other exchanges and to immediately execute or book the order.

One or more trades for any matched orders are executed, at 90. If no rested orders match the new order, then no trades are executed.

At 92, the order matching engine 42 determines whether the entirety of the new order has been filled. If so, the method ends.

If the new order was not completely filled or not filled at all, then the order matching engine 42 determines, at 94, whether the remainder (or entirety) of the new order would cause the market to be locked if rested in the order book database 30. That is, if the price specified in the new order meets the price specified in the highest ranked rested order, but the new order cannot be matched to the highest ranked rested order because a minimum rebate give-up specified for the new order is not met (or for any other reason) then the market would be locked. That is, the price of the highest ranked bid order and the price of the highest ranked offer order meet, but the trade is prevented by an unmet rebate give-up condition. If it is determined that the market would lock, then the new order or remainder thereof is processed according to a lock-avoidance contingency, and the order matching engine 42 can report such to the order gateway 40 for informing the entity that placed the new order. The lock-avoidance contingency can include one or more of killing the order or remainder thereof, booking the order or remainder thereof at the specified price, booking the order or remainder thereof at a different price level, and similar. Various lock-avoidance contingencies can be specified with the order, can be stipulated as policy by the trading server 12, or both, and may be necessary to comply with market regulations of the legal jurisdiction in which the trading server 12 operates.

If it is determined that the market would not lock, then the new order or remainder thereof is rested, at 96, in the order book database 30. A resting rebate give-up, if specified with the new order, is used when the rested new order is ranked for matching with subsequent new orders.

Broker preferences may also be used as a parameter by the order matching engine 42 when matching orders. For example, rested orders may be ranked based on price, then broker preference, then fee indication, and finally timestamp.

As mentioned, rebate give-ups may be limited to a preselected set, which simplifies selection by trading entities and further places caps on the maximum fees and rebates. An examples preselected set of fees/rebates for active/passive orders is as follows: 35/−31 (i.e., 35 mils fee for active order and 31 mils rebate for passive order), 30/−26, 25/−21, 20/−16, 15/−11, 10/−6, 5/−1, 0/4, −5/9, −10/14, −15/19, −20/24.

FIG. 5 shows examples of rested orders in the order book database 30. As can be seen, the rested offer orders 34 are ranked based on price 64, then rebate give-up 52, and finally timestamp 66. Volume 62 and broker ID 100 are also shown. As can be seen, orders at the same price are ranked by descending rebate give-up. Where rebate give-up is the same, the oldest orders are given higher priority.

Assuming a 31 mil base rebate for passive orders and a 35 mil base fee for active orders, various example scenarios for new incoming bid orders will now be discussed with reference to the example data shown in FIG. 5.

In a first scenario, broker ID 9 places an order to buy 300 shares at 10.01 with no minimum rebate give-up. The result is that broker ID 9 trades 100 shares with each of broker IDs 2, 7, and 9 with respective fees/rebates of 15/−11, 20/−16, and 30/−26. Hence, broker ID 9 pays fees at 15 mils, 20 mils, and 30 mils, and broker IDs 2, 7, and 9 are issued rebates of 11 mils, 16 mils, and 26 mils, respectively.

In a second scenario, broker ID 9 places an order to buy 300 shares at 10.01 with a minimum rebate give-up of 15 mils and specifying immediate-or-cancel (IOC). The result is that broker ID 9 trades 100 shares with each of broker IDs 2 and 7 with respective fees/rebates of 15/−11 and 20/−16. The unfilled remainder of 100 shares is killed.

In a third scenario, with the highest booked bid order is at 10.00, broker ID 9 places an order to buy 300 shares at 10.01 with a minimum rebate give-up of 15 mils. The result is that broker ID 9 trades 100 shares with each of broker IDs 2 and 7 with respective fees/rebates of 15/−11 and 20/−16. The unfilled remainder of 100 shares is killed rather than being booked because booking such a bid order at 10.01 while offer orders at 10.01 remain would lock the market.

Other scenarios are also contemplated, and interactions or conflicts between rebate give-ups and broker preferences can be handled in various manners.

FIG. 6 shows example fields or tags that are contemplated to be added to existing order protocols to support the techniques discussed herein. Such fields or tags have been discussed extensively above and the above description can be referenced. The maximum fee or minimum rebate, as the case may be, can be used to specify a maximum fee at which the order will fill or a minimum rebate at which the order will fill. A condition can be placed on orders specifying this field requiring that the order have a duration, after which the order or unfilled portion thereof is killed, booked, booked at a different price level, or processed according to a contingency, such as the market lock-avoidance contingencies discussed above. The passive (resting) rebate give-up field identifies the rebate give-up used if the order is booked. This field is public, so that feeds 56 may contain such data, as discussed. Rebate peg offset and rebate peg limit are fields that allow selection of an amount by which to peg the order's rebate and a limit for such pegging.

The techniques discussed above allow the market to self-determine optimal fee/rebate values within a controlled range. Ranking the order book database by fee/rebate allows for an increase level of competition not realized by known models, such as fixed fees/rebates or the option to credit the rebate to the active participant. Moreover, transparency by opening the fee/rebate ranked order book to the public allows market participants to plan and act accordingly.

While the foregoing provides certain non-limiting example embodiments, it should be understood that combinations, subsets, and variations of the foregoing are contemplated. The monopoly sought is defined by the claims.

What is claimed is:

1. A method of matching orders for a financial security in a computerized trading system, the method comprising:
receiving a new order from a first computer of a first trading entity;
ranking rested orders in an order book database based on fee indications of the rested orders, each fee indication representative of a fee amount charged to the first trading entity for executing a trade between the new order and each respective rested order; and
matching the new order to one or more rested orders at a same price according to the ranking.

2. The method of claim 1, further comprising executing a trade between the first trading entity and a second entity based on the new order and at least one matching rested order.

3. The method of claim 1, further comprising resting a remainder of the new order when the new order is not completely filled by matching rested orders.

4. The method of claim 3, wherein the new order specifies a resting fee indication, and the remainder of the new order is rested with the resting fee indication.

5. The method of claim 1, wherein each fee indication is a rebate differential from a base rebate.

6. The method of claim 5, wherein the new order specifies a minimum rebate differential, and the matching further comprises matching the new order to rested orders that have a rebate deferential that is greater than or equal to the minimum rebate differential.

7. A method of matching orders for a financial security in a computerized trading system, the method comprising:
receiving an order for a financial security from a first computer operating on behalf of a first trading entity, the order specifying a price at which to match the order and a fee indication for executing a trade based on the order;
resting the order in an order book database;
within the order book database, prioritizing the order among other orders for the financial security at a same price, the prioritizing being based on the fee indication; and
matching the order to a new order at the same price, the new order originating from a second computer operating on behalf of a second trading entity.

8. The method of claim 7, further comprising:
rebating the first trading entity a rebate amount determined from the fee indication; and
charging the second training entity a fee amount determined from the fee indication.

9. The method of claim 7, wherein the fee indication is represented as a rebate differential from a base rebate.

10. The method of claim 9, wherein the prioritizing ranks orders at the same price by descending rebate differential.

11. The method of claim 9, further comprising providing a limited set of rebate differentials for selection by trading entities.

12. The method of claim 7, wherein the new order specifies a fee indication, and matching the order to the new order comprises comparing the fee indication of the order to the fee indication of the new order.

13. The method of claim 7, further comprising executing a trade of the financial security based on the order and the new order.

14. A computer system comprising:
at least one server configured to receive orders for financial securities and to process received orders including resting orders in an order book database;
the server further configured to charge fees and provide rebates for executed trades; and
the server further configured to maintain the order book database to match incoming orders with rested orders based on price, and to prioritize rested orders at a same price based on fee or rebate.

15. The system of claim 14, wherein the server is further configured to execute trades between entities based on incoming orders and matching rested orders.

16. The system of claim 14, wherein the server is further configured to rest a remainder of an incoming order when the incoming order is not completely filled by matching rested orders.

17. The system of claim 16, wherein the incoming order specifies a resting fee indication, and the remainder of the incoming order is rested with the resting fee indication.

18. The system of claim 14, wherein the server is further configured to rank rested orders in the order book database based on fee indications of the rested orders, each fee indication representative of a fee amount charged to a trading entity for executing a trade with the respective rested order.

19. The system of claim 18, wherein each fee indication is a rebate differential from a base rebate.

20. The system of claim 19, wherein the server is further configured match an incoming order to rested orders that have a rebate deferential that is greater than or equal to a minimum rebate differential indicated with the incoming order.
